(19) United States
(12) Patent Application Publication
(10) Pub. No.: US 2011/0228533 A1
(43) Pub. Date: Sep. 22, 2011

(54) LED TRAFFIC LAMP

(75) Inventor: Jungyoul Lim, Gwangju-si (KR)

(73) Assignee: DAE RYUK ITS CO., LTD., Seongnam-si (KR)

(21) Appl. No.: 13/150,348

(22) Filed: Jun. 1, 2011

Related U.S. Application Data
(63) Continuation of application No. PCT/KR2009/007224, filed on Dec. 4, 2009.

(30) Foreign Application Priority Data
Dec. 5, 2008 (KR) 10-2008-0122954
Aug. 20, 2009 (KR) 10-2009-0076995

(51) Int. Cl. F21V 1/00

(52) U.S. Cl. 362/237

(57) ABSTRACT

In the present invention, in a traffic light in which a plurality of LEDs is disposed for each color, a plurality of visors is disposed in a traffic light generating the same color, and LEDs are disposed in respective visors. Accordingly, the spread angle of the LED can be efficiently limited and the influence of the wind can be minimized.

### REFERENCE TO RELATED APPLICATIONS

This is a continuation of pending International Patent Application PCT/KR2009/007224 filed on Dec. 4, 2009, which designates the United States and claims priority of Korean Patent Application No. 10-2008-0122954 filed on Dec. 5, 2008 and Korean Patent Application No. 10-2009-0076995 filed on Aug. 20, 2009, the entire contents of which are incorporated herein by reference.

### FIELD OF THE INVENTION

The present invention relates to a Light-Emitting Diode (LED) traffic lamp in which a plurality of sun screens (hereinafter referred to as “visors”), disposed in the LED traffic lamp and configured to limit the spread angle of light, is disposed in a traffic light for displaying one color and one or more LEDs are disposed in each of the visors.

### BACKGROUND OF THE INVENTION

A traffic light is disposed towards the front of a vehicle which typically travels on a road in one direction and is configured to have a visor for limiting a spread angle in order to prevent vehicles, traveling in the other direction, from confusing.

FIG. 1 is a perspective view of a conventional LED traffic lamp.

The conventional LED traffic lamp 10 includes a housing 1 configured to have circuit boards and a power supply apparatus embedded therein, a plurality of LED groups 2 disposed on one side of the housing 1, each configured to have LEDs grouped in the circuit board in a concentric circle way, and configured to emit lights of red, green, and orange color, respectively, transparent protection caps disposed in the LED groups 2 and configured to protect the individual LEDs forming the LED groups, and visors 3 configured to limit the spread angle of light from the respective LED groups 2 to 40 in order to prevent drivers who see the traffic light in the other direction from confusing.

The visor 3 is made of an opaque material and is configured to have a cylindrical shape downward opened from the outer circumference of the LED group 2 and to prevent the spread of light. Accordingly, the visor 3 is configured to have only drivers within a certain angle of a center line along which the light of the LED group 2 travels see the light of the LED group 2.

However, the support of the traffic light has to be reinforced because the visors 3 have the traffic light weighted down with wind pressure, and the visors 3 are fluctuated by the wind and are separated from the traffic light.

Furthermore, the visors 3 protruded from the traffic light hinder injure a beautiful sight.

### SUMMARY OF THE INVENTION

Accordingly, the present invention has been made in view of the above problems occurring in the prior art, and an object of the present invention is to improve an urban beautiful and also limit the spread angle of a traffic light by installing a plurality of visors and disposing one or more LEDs within each of the visors in the traffic light in which the plurality of LEDs is disposed and displayed.

To achieve the above object, the present invention provides a Light-Emitting Diode (LED) traffic lamp, having an opening portion formed on the front side so that light generated from a plurality of LEDs is emitted and having a circuit board for turning on the LEDs disposed therein, the LED traffic lamp, including the LEDs disposed on the front side of the circuit board, and a visor disposed in the outer circumference of each of the LEDs and configured to limit a spread angle of the light of the LED.

To achieve the above object, the present invention provides an LED traffic lamp, having an opening portion formed on the front side so that light generated from a plurality of LEDs is emitted and having a circuit board for turning on the LEDs disposed therein. The LED traffic lamp includes a visor plate disposed on the front side of the circuit board and configured to have visor holes formed therein, wherein the visors holes have the respective LEDs disposed therein, have an identical number with the LEDs, and limit respective spread angles of the LEDs.

To achieve the above object, the present invention provides an LED device, having an opening portion formed on the front side so that light generated from a plurality of LEDs is emitted and having a circuit board for turning on the LEDs disposed therein. The LED traffic lamp includes the LEDs disposed on the front side of the circuit board; and a visor disposed in the outer circumference of each of the LEDs and configured to limit a spread angle of the light of the LED. The LED device is one of an LED electric bulletin board, an LED signboard, and an LED electric sign.

To achieve the above object, the present invention provides an LED traffic lamp, including a circuit board configured to have a plurality of LEDs disposed on the front side thereof; and a plurality of visors disposed in the circuit board and each configured to limit a spread of light of LEDs emitting an identical color, from among the LEDs. One or more LEDs are disposed within the visor.

To achieve the above object, the present invention provides an LED traffic lamp, including a circuit board configured to have a plurality of LEDs disposed therein; and a visor plate disposed on the front side of the circuit board and configured to have a plurality of visor holes formed therein. Each of the visor holes is configured to have the one or more LEDs disposed therein and to limit a spread angle of light emitted from the one or more LEDs.

According to the present invention having the above object and the technical solution, the spread angle of an LED traffic lamp is limited, but there is not visor externally protruded. Accordingly, the influence of the wind is not affect, and an urban beauty can be improved because design is possible in various ways.

### BRIEF DESCRIPTION OF THE DRAWINGS

FIG. 1 is a perspective view of a conventional LED traffic lamp;

FIG. 2 is a cross-sectional view showing an LED traffic lamp according to a first embodiment of the present invention;

FIG. 3 is a plan view showing a state in which LEDs arranged in a circuit board are disposed in the LED traffic lamp shown in FIG. 2;

FIG. 4 is a perspective view of each LED and each visor disposed in FIG. 2;

FIG. 5 is a plan view showing the LED and the visor disposed in

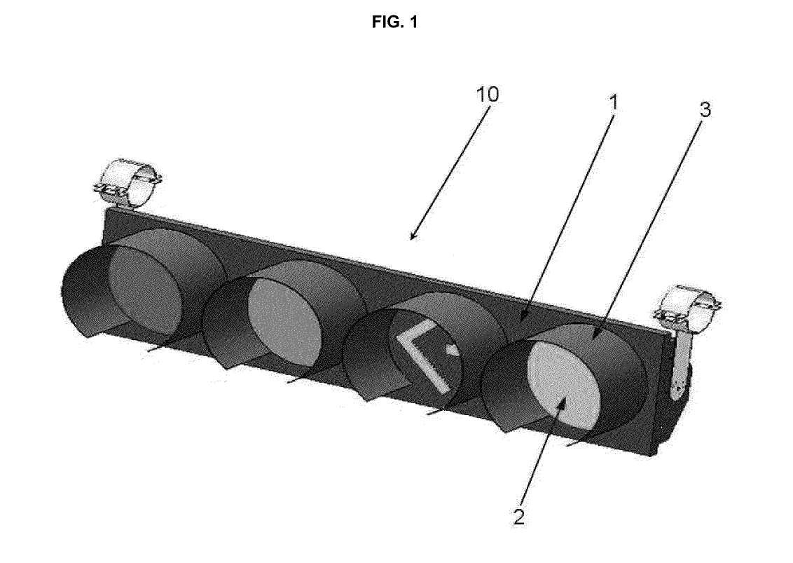

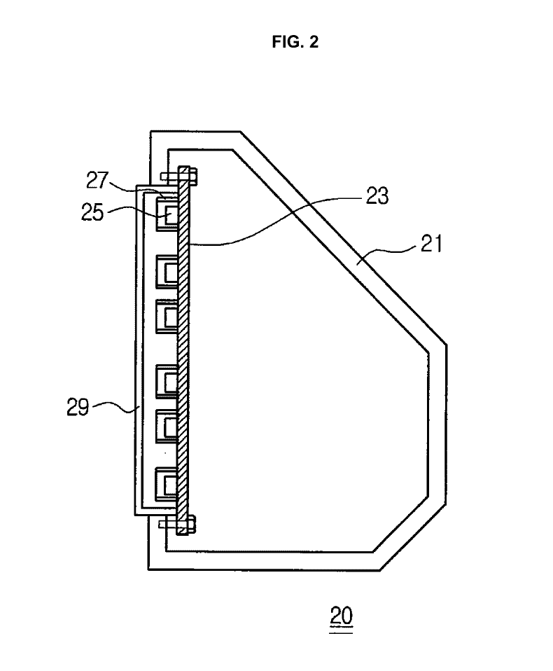

FIG. 2;

FIG. 6 is a perspective view showing a state in which a protection cap is disposed in the circuit board having the LEDs arranged therein in FIG. 2;

FIG. 7 is a perspective view illustrating integral parts of an LED traffic lamp according to a second embodiment of the present invention;

FIG. 8 is a cross-sectional view taken along line A-A′ in FIG. 7;

FIG. 9 is a front view showing another form of a visor hole formed in an LED traffic lamp according to the second embodiment of the present invention;

FIG. 10 shows a configuration illustrating a third embodiment of the present invention;

FIG. 11 shows a configuration illustrating a fourth embodiment of the present invention;

FIG. 12 shows a configuration illustrating a fifth embodiment of the present invention; and

FIG. 13 shows a configuration illustrating a sixth embodiment of the present invention.

### DETAILED DESCRIPTION OF THE INVENTION

Embodiments of the present invention are described below with reference to the accompanying drawings.

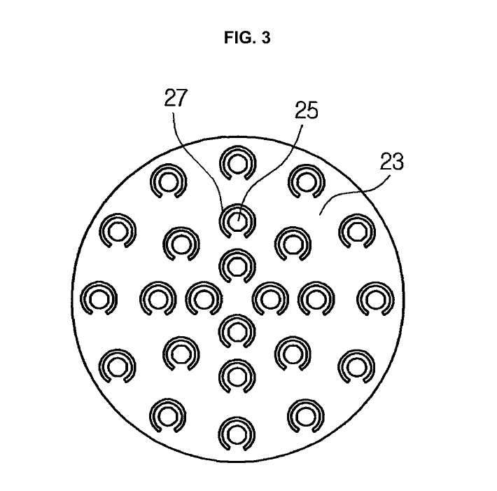

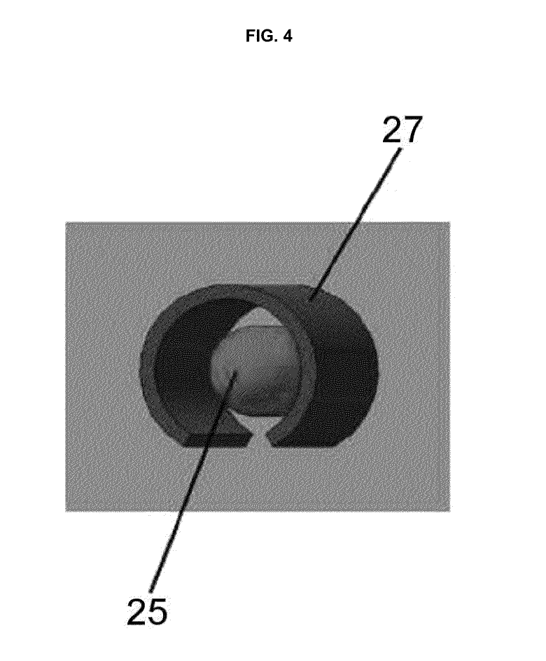

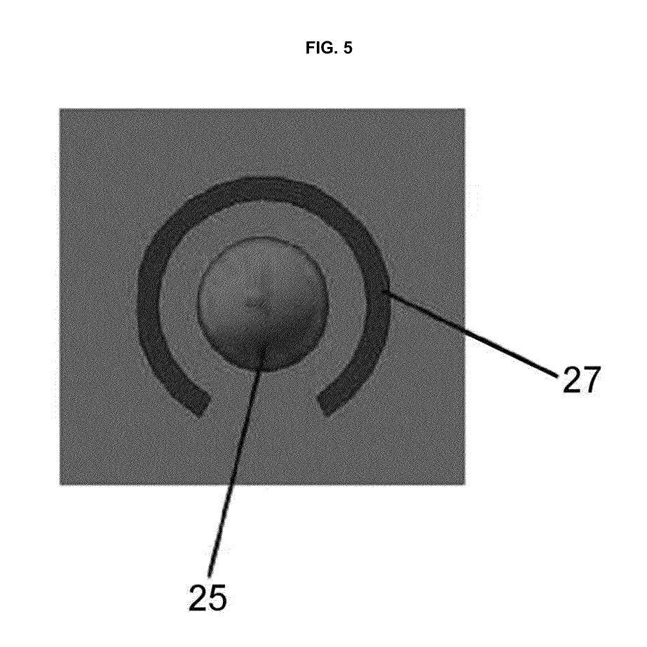

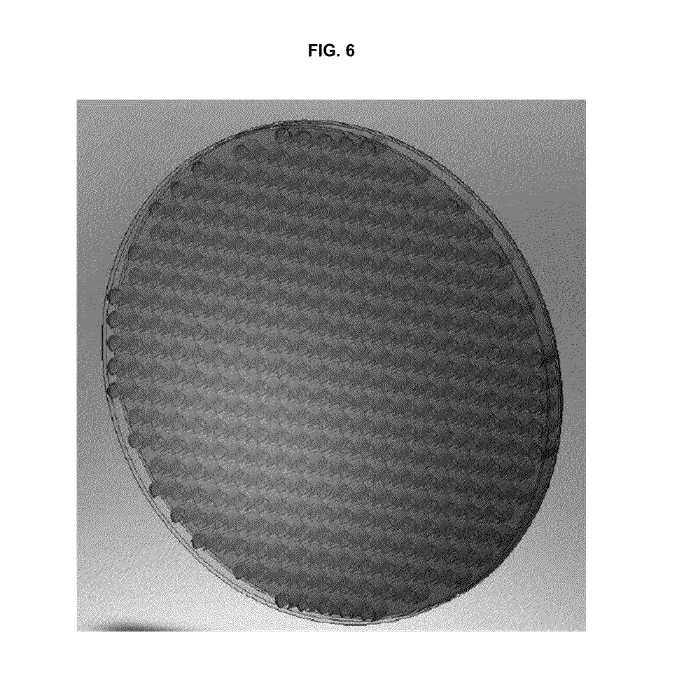

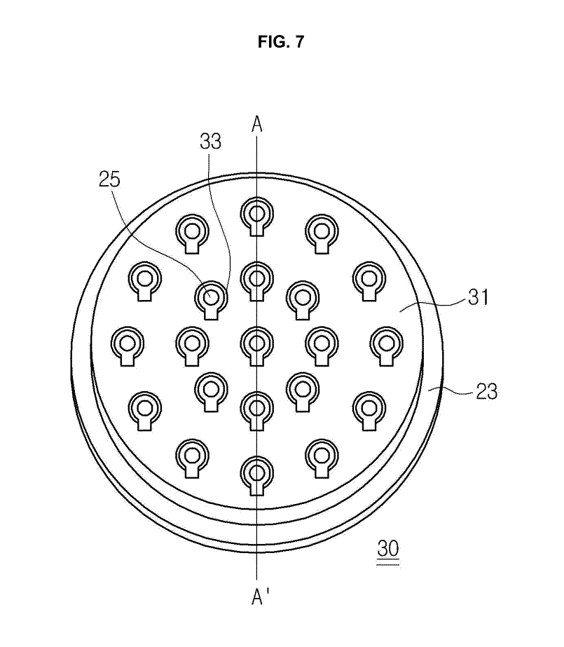

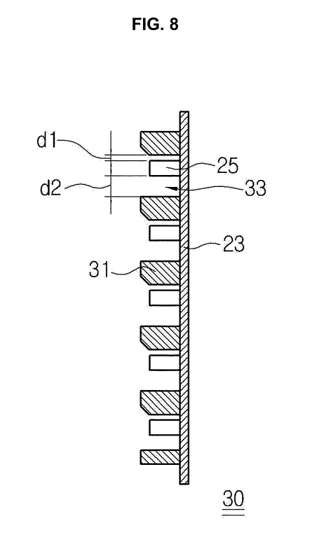

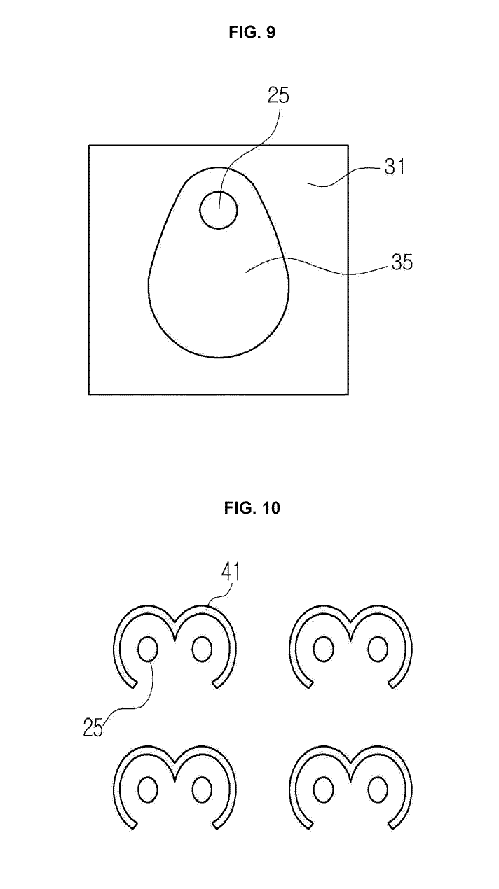

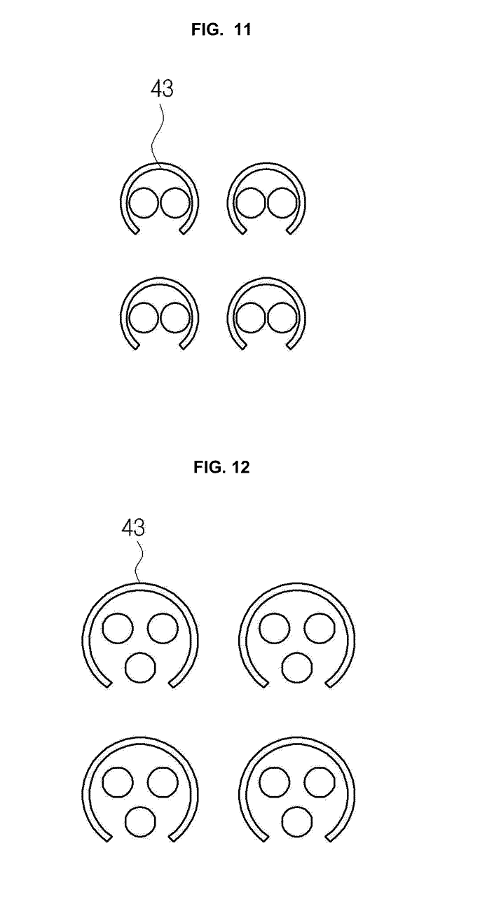

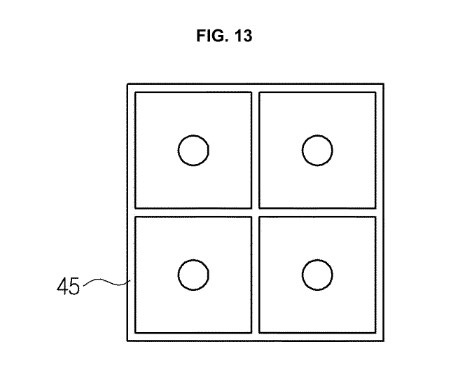

FIG. 2 is a cross-sectional view showing an LED traffic lamp according to a first embodiment of the present invention. FIG. 3 is a plan view showing a state in which LEDs arranged in a circuit board are disposed in the LED traffic lamp shown in FIG. 2. FIG. 4 is a perspective view of each LED and each visor disposed in FIG. 2. FIG. 5 is a plan view showing the LED and the visor disposed in FIG. 2. FIG. 6 is a perspective view showing a state in which a protection cap is disposed in the circuit board having the LEDs arranged therein in FIG. 2.

The LED traffic lamp 20 of the first embodiment includes a circuit board 23 in a housing 21 having a circular opening portion formed on the front side thereof and a plurality of LEDs 25 disposed in the circuit board 23 and configured to emit light toward the opening portion. The LED traffic lamp 20 further includes visors 27 disposed around the respective LEDs 25 and each configured to limit the spread of light of the LED 25.

As shown in FIGS. 4 and 5, the visor 27 has a cylinder having a lower portion opened. The diameter of the cylinder is greater than the diameter of an outer circumference of the LED 25, and the length of the visor 27 protruded from a surface of the circuit board is longer than the length of the LED 25 protruded from the surface of the circuit board.

The LED traffic lamp 20 further includes a transparent protection cap 29 disposed on the front side of the visor 27 and configured to protect the LEDs 25 and the visors 27.

Furthermore, a power supply unit (not shown) supplies power to the circuit board 23 and turns on the LEDs 25.

In the LED traffic lamp 20 of the first embodiment, the circuit board 23, the LEDs 25, and the protection cap 29 are illustrated to be fixed to the housing 21. It is to be noted that those skilled in the art will understand that the circuit board 23, the LEDs 25, and the protection cap 29 may be integrated into one device which can be attached to or detached from the housing 21 as one lighting.

FIG. 7 is a perspective view illustrating integral parts of an LED traffic lamp according to a second embodiment of the present invention, and FIG. 8 is a cross-sectional view taken along line A-A′ in FIG. 7.

In the first embodiment, the number of working processes is increased because the visors 27 are disposed for the respective LEDs 25. In order to solve the problem, in the LED traffic lamp 30 according to the second embodiment of the present invention, a visor plate 31 having a plurality of visor holes 33 formed therein is disposed on the front side of a circuit board 23, instead of the visors 27. LEDs 25 are disposed in the respective visor holes 33.

A description of the LED traffic lamp 30 of the second embodiment, having the same parts as the first embodiment, is omitted, and a difference between the second embodiment and the first embodiment is described.

The plurality of LEDs 25 is disposed on the front side of the circuit board 23. Furthermore, the visor plate 31 is made of an opaque material and is configured to have the visor holes 33 formed therein. The visor plate 31 is disposed on the front side of the circuit board 23 and is configured to emit light of the LEDs 25 toward the front, but limit the spread angle of the light.

The visor holes 33 having the same number as the LEDs 25 are formed in the visor plate 31. Each of the visor holes 33 has a cylinder hole shape, having a sidewall greater than the outside diameter of the LED 25, and has a groove downward elongated in order not to prevent light of the LED 25 from being downward spread.

As shown in FIG. 8, assuming that a distance between a top surface of the LED 25 and a top portion of the inside wall of the visor hole surrounding the LED 25 is d1 and a distance between the bottom surface of the LED 25 and a bottom portion of the inside wall of the visor hole surrounding the LED 25 is d2, the distance d2 is greater than the distance d1.

FIG. 9 is a front view showing another form of a visor hole formed in an LED traffic lamp according to the second embodiment of the present invention.

The visor hole 33 shown in FIG. 8 is formed to have the cylindrical hole and the square-shaped hole extended from the bottom of the cylindrical hole, whereas the visor hole 35 shown in FIG. 9 has a curved surface whose upper portion is narrow and lower portion is wide around the center of the LED 25. Accordingly, the spread angle of light of the LED 25 is wide towards the surface of the land, but narrow towards the upper side.

The first embodiment and the second embodiment of the present invention relate to the LED traffic lamp, but are not limited to the LED traffic lamp. For example, the present invention may be applied to LED devices (e.g., LED electric bulletin boards, LED signboards, and LED electric signs) in which a visor for limiting the range of a spread angle is used.

FIG. 10 shows a configuration illustrating a third embodiment of the present invention.

In the third embodiment, a plurality of LEDs 25 and a plurality of visors 41 are disposed in the circuit board 23 (refer to FIGS. 7 and 8). Each of the visors 41 includes a pair of curved surfaces, each having a half-cylindrical shape and having a lower portion opened. Each of the LEDs 25 is disposed within the pair of curved surfaces each having the half-cylindrical shape.

FIG. 11 shows a configuration illustrating a fourth embodiment of the present invention.

In the fourth embodiment shown in FIG. 11, a plurality of LEDs 25 and a plurality of visors 43 are disposed in the circuit board 23 (refer to FIGS. 7 and 8). Two LEDs 25 are disposed within each of the visors 43. Here, each of the visors 43 has a cylindrical shape, but has a lower portion opened.

FIG. 12 shows a configuration illustrating a fifth embodiment of the present invention.

In the fifth embodiment shown in FIG. 12, three LEDs 25 are disposed in each visor having the same shape as shown in the fourth embodiment of FIG. 11.

FIG. 13 shows a configuration illustrating a sixth embodiment of the present invention.

The sixth embodiment shown in FIG. 13, a visor 45 is configured to have a quadrangle mesh shape having quadrangles consecutively formed therein and is disposed in the circuit board 23 (refer to FIGS. 7 and 8). One or two or more LEDs are disposed in the quadrangle mesh shape.

Furthermore, visor holes, having the same shape as the visors shown in FIGS. 10 to 13, may be formed in the visor plate 31 shown in FIG. 7. One or two or more LEDs may be disposed in each visor hole. In this case, the number of working processes can be reduced.

The device in which the visors or the visor plate according to the present invention is not limited to an LED traffic lamp, but may be applied to LED electric bulletin boards, LED signboard, and LED electric signs. The scope of the present invention is defined by the accompanying claims.

What is claimed is:

1. A Light-Emitting Diode (LED) traffic lamp, having an opening portion formed on a front side so that light generated from a plurality of LEDs is emitted and having a circuit board for turning on the LEDs disposed therein, the LED traffic lamp, comprising:
the LEDs disposed on the front side of the circuit board, and
a visor disposed in an outer circumference of each of the LEDs and configured to limit a spread angle of the light of the LED.

2. The LED traffic lamp according to claim 1, wherein the visor has a portion, facing a surface of land, opened and has a cylindrical shape having a diameter greater than a diameter of the LED.

3. The LED traffic lamp according to claim 1, wherein a length of the visor, protruded from the front side of the circuit board, is greater than a length of the LED, protruded from the front side of the circuit board.

4. An LED traffic lamp, having an opening portion formed on a front side so that light generated from a plurality of LEDs is emitted and having a circuit board for turning on the LEDs disposed therein, the LED traffic lamp, comprising:
a visor plate disposed on the front side of the circuit board and configured to have visor holes formed therein, wherein the visors holes have the respective LEDs disposed therein, have an identical number with the LEDs, and limit respective spread angles of the LEDs.

5. The LED traffic lamp according to claim 4, wherein each of the visor holes comprises:
a cylindrical portion configured to have a diameter greater than an outside diameter of the LED; and
a square portion elongated from a bottom of the cylindrical portion toward a surface of land.

6. The LED traffic lamp according to claim 4, wherein the visor hole has a curved shape, having a greater distance from an upper side to a lower side based on the surface of land.

7. The LED traffic lamp according to claim 4, wherein a length of the visor plate, protruded from the front side of the circuit board, is greater than a length of the LED, protruded from the front side of the circuit board.

8. An LED device, having an opening portion formed on a front side so that light generated from a plurality of LEDs is emitted and having a circuit board for turning on the LEDs disposed therein, the LED traffic lamp, the LED device comprising:
the LEDs disposed on a front side of the circuit board; and
a visor disposed in an outer circumference of each of the LEDs and configured to limit a spread angle of the light of the LED,
wherein the LED device is one of an LED electric bulletin board, an LED signboard, and an LED electric sign, and

9. An LED traffic lamp, comprising:
a circuit board configured to have a plurality of LEDs disposed on a front side thereof; and
a plurality of visors disposed in the circuit board and each configured to limit a spread of light of LEDs emitting an identical color, from among the LEDs,
wherein one or more LEDs are disposed within the visor.

10. The LED traffic lamp according to claim 9, wherein the visor has a cylindrical shape having a lower portion opened.

11. The LED traffic lamp according to claim 9, wherein the visor has a consecutive polygonal mesh shape.

12. An LED traffic lamp, comprising:
a circuit board configured to have a plurality of LEDs disposed therein; and
a visor plate disposed on a front side of the circuit board and configured to have a plurality of visor holes formed therein, wherein each of the visor holes is configured to have the one or more LEDs disposed therein and to limit a spread angle of light emitted from the one or more LEDs.
